(19) United States
(12) Patent Application Publication
(10) Pub. No.: US 2022/0156862 A1
(43) Pub. Date: May 19, 2022

(54) SYSTEM AND METHOD FOR ANALYZING GRANTABILITY OF A LEGAL FILING

(71) Applicant: Hammurabi Legal Analytics, LLC, Silver Spring, MD (US)

(72) Inventors: Daniel Rabinowitz, Silver Spring, MD (US); Yehoshua Carmi Levine, Jerusalem (IL)

(73) Assignee: Hammurabi Legal Analytics, LLC, Silver Spring, MD (US)

(21) Appl. No.: 17/526,413

(22) Filed: Nov. 15, 2021

Related U.S. Application Data
(60) Provisional application No. 63/114,063, filed on Nov. 16, 2020.

(51) Int. Cl. G06Q 50/18; G06F 40/295

(52) U.S. Cl. CPC G06Q 50/18; G06F 40/295

(57) ABSTRACT

A gradient boosted networked computer system permits users to analyze the grantability of potential legal filings associated with a target entity, using specific externally reported data. By analyzing the target filing and judicial prerogatives, embodiments of the invention can assess, present, and predict outcomes and timings of decisions made by a judge before the filings are submitted.

### CROSS-REFERENCE TO RELATED APPLICATION

This application claims the benefit of U.S. Provisional Application No. 63/114,063, titled, “System And Method For Analyzing Grantability Of A Legal Filing,” filed Nov. 16, 2020, the content of which is incorporated herein by reference in its entirety.

### TECHNICAL FIELD

The present invention relates to systems and methods for collecting, compiling, and analyzing data concerning courts and related processes to predict the outcome of certain legal filings. The invention has particular applicability in assisting companies, legal practitioners, and stake holders (particularly litigants) to identify and profile hidden or opaque judicial proclivities in order to develop litigation strategies.

### BACKGROUND

Each day thousands of litigants initiate and participate in legal proceedings. In all situations, the parties must decide where to file cases, what motions to file, and many other case determinative decisions. There is a significant legal cost incurred by the parties in preparing, filing, and advancing cases and motions. If a motion is granted, the case may be dismissed or place the winning party in a stronger position when it comes to settlement talks, however, if the motion is denied, the costs associated with the filing cannot be recovered.

Most of the time, when parties go before a judge or other judicial official asking that person to decide, either at trial or in pre-trial motions, there is uncertainty and unpredictability about the outcome. When it is crystal clear that a party has either a definitively winning or a definitively losing position, chances are that the opposing parties and lawyers will have tried to resolve it and settle the motion or the whole dispute before that point. Often, unpredictability and uncertainty prevent matters from settling and results in an unnecessarily high legal bill. There are numerous reasons why litigation may be unpredictable and outcomes uncertain.

There are often gaps in the law. In some instances, the application of decided case law or statutes that can be applied to the facts of a case may be murky or fact or case specific. In other instances, the damage caused, or the remedies sought may be novel. The simple problem is lawyers are often called upon to draw analogies from established case law and those inferences are not always crystal clear. Further complicating the matter is different judges on the same court may take different approaches when it comes to rendering certain decisions, which may be case specific. One judge may issue decisions quickly, while another takes over six months to decide a matter. One may be more receptive to granting a motion to dismiss on a certain issue, while another one may be less receptive. This uncertainty in the timing of the issuance and the decision itself increases legal costs as lawyers may undertake unnecessary actions during the time a decision is pending or advance motions that are unlikely to be granted by the presiding judge.

Unsurprisingly, predicting how a judge will decide issues is one of the great pastimes for legal and political observers. Every year, newspapers, television, and radio pundits, academic journals, law reviews, magazines, blogs, and tweets predict when and how courts may rule in a particular case. Will the decision come this week? Will the judge vote based on the political preferences of the President who appointed them, advance theories they put forth in filings they authored before being appointed to the bench, or buck expectations with an entirely unexpected ruling? Will the judge exercise bias toward certain types of litigants or certain matters?

Despite the multitude of pundits and vast human effort devoted to the task, the quality of the predictions and the underlying models supporting most forecasts is unclear. Not only are these models not back-tested historically, but many are difficult to formalize or reproduce at all. When models are formalized, they are typically assessed ex post to infer causes, rather than used ex ante to foretell future cases. The best test of an explanatory theory is its ability to foretell future events. To the extent that scholars in both disciplines (social science and law) seek to explain court behavior, their theories need to be able to foretell future outcomes based, in part, on prior judicial decisions, the litigants, the facts, and the nature of the cause of action.

One predictive model is known as gradient boosting. Gradient boosting is a machine learning technique for regression and classification problems that seeks to combine weak models, into a single strong model in an iterative fashion. As each weak model is added, a new model is fitted to provide a more accurate estimate of the response variable. The new weak models are maximally correlated with the negative gradient of the loss function, associated with the whole ensemble. The difficulty with gradient boosting is identifying which specific data or sets of data to select to model and combine to produce the most accurate predictive model. Furthermore, one must be careful not to try to model all the data available, because that can lead to undesirable overfitting. The essence of overfitting is a gradient boosted model that has unknowingly extracted some of the residual variation (i.e., the noise) of its data. This goldilocks principle has stymied the use of gradient boosting predictive modeling to analyze the likely outcomes of a legal filing and its timing.

As a result, there is a need for a system and method, using only specifically identified types of data available prior to a judicial decision, to analyze and foretell when and how a specific judge faced with a specific issue surrounding specific parties represented by specific law firms will rule. By restricting the analysis to the specific data set discussed below, the disclosed system and method can foretell, within a statistically significant greater degree of accuracy, how judges will rule on a specific issue before a legal filing is even submitted. With such information, lawyers can more effectively map out a client's legal strategy, thereby reducing the unnecessary legal spend of their clients.

### SUMMARY

This invention is a system or a method to boost the ability to analyze and quantify the grantability of a legal filing.

The system indirectly analyzes data and provides a likelihood that a legal filing being considered will be granted (or denied) and how soon it will be granted or denied. The system includes a software application operating on a mobile computer device or on a computer device, which is in communication with a user. The application is configured to receive the following subject information from the user: a docket number and jurisdiction linked to a specific case. In addition, the user identifies the legal filing he or she is considering filing. The software application then communicates the subject information through a wired and/or wireless communication network to a server located at a site where the user is physically present or at a location remote from the site. The system also includes a processor that is in communication through the wired and/or wireless communication network with the software application, as well as the server. The processer is configured to request and receive from either an electronic public access service of the United States that provides federal court documents, the user, or an employee or agent of the user: (1) the names of parties to the case; (2) the names of law firms linked to each party; (3) the name of the judge assigned to the case; and (4) the nature of the suit. The processor then classifies, using natural processing language as applied to the names: (1) each party as a corporation, individual, union, government, or other. If the party is a corporation, the processor further classifies the party by size. Regarding law firms, the processor classifies those by size. Specifically, each firm is either a solo practitioner, small firm, medium firm, large firm. In addition, the law firms may be classified as Am 100 or Am200 firms. The processor also recalls from a database of the system numeric values linked to the classification of: (a) the party type, (b) the corporation size, (c) the law firm size, (d) the nature of the suit, (e) the type of filing (e.g., motions for judgment on the pleadings and filings invoking Federal Rule of Civil Procedure 12(b)(1)-(6), 12(e) or 12(f)), and along with, (f) prior numeric values linked to a prior decision history of the judge in relation to the legal filing being considered that have been previously uploaded to the database by a programmer or an employee, contractor, or agent of the programmer. The processor converts the classification to numeric values to create a new entry and creates a vector using the new entry and the prior numeric values. Finally, the processor solves the new vector using a gradient boosted trees classifier to determine the likelihood that the judge will grant the legal filing and transmits the resulting solution to the software application for display to the user.

In certain embodiments, the prior decision history further contains the length of time the judge took to issue prior decisions and the processor averages these time periods and transmits the average length of time to the software application for display to the user.

A method for indirectly analyzing and providing a likelihood that a legal filing being considered will be granted is also disclosed. The method includes receiving the following initial information that has been provided by a user using a software application operating on a mobile computer device or a computer device that is synchronized with the mobile computer device: a docket number and jurisdiction linked to a specific case, and an identification of the legal filing the user is considering submitting. Next, the following additional information from either an electronic public access service of United States that provides federal court documents, the user, or an employee or agent of the user is received: (1) the names of parties to the case; (2) the names of law firms linked to each party; (3) the name of judge assigned to the case; and (4) the nature of the suit. Upon receiving the additional information, the information is classified, using natural processing language as applied to the names: (1) each party as a corporation, individual, union, government, or other, wherein the corporations are further classified by size and (2) each law firm is a solo, small firm, medium firm, large firm, or Am100 or Am200 firm. Upon receiving the additional information, the method calls up: numeric values linked to the classification of (a) the party type, (b) the corporation size, (c) the law firm size, (d) the nature of the suit, (e) the type of filing, along with, prior numeric values linked to a prior decision history of the judge in relation to the legal filing being considered. Such numeric values had been previously uploaded to the database by a programmer or an employee, contractor, or agent of the programmer. The classifications are then converted to the numeric values to create a new entry. Using the new entry and prior numeric values from the judge's decision history, a vector is created. The vector is solved using a Gradient Boosted Trees classifier to determine the likelihood that the judge will grant the legal filing. Finally, the results are displayed to the user.

Just like the system, the prior decision history received in the method may further contain the length of time the judge took to issue prior decisions and the method may also include the step of determining the average time that the judge takes to issue prior decisions on related filings and displaying the results to the user.

### BRIEF DESCRIPTION OF THE DRAWINGS

Additional aspects, features, and advantages of the invention, both as to its structure, assembly, and use, will be understood and will become more readily apparent when the invention is considered in light of the following description of illustrative embodiments made in conjunction with the accompanying drawings, wherein:

FIG. 1 illustrates an embodiment of the system hardware architecture.

FIG. 2 illustrates an embodiment of the system information flow architecture.

FIG. 3 illustrates an embodiment of a display depicting the resulting solution of the likelihood that the judge will grant the legal filing.

FIG. 4 illustrates an embodiment of a display depicting the average time to issue a decision by a judge.

FIG. 5 illustrates an embodiment of a display depicting both the resulting solution of the likelihood that the judge will grant the legal filing and the average time the judge will take to issue a decision.

FIG. 6 illustrates an embodiment of a display depicting a filtering function by likelihood of motion grantability.

FIG. 7 illustrates an embodiment of a display depicting the results of the filter function depicted in FIG. 6.

### DETAILED DESCRIPTION

Various embodiments of the invention are described in detail below. Although specific implementations are described, it should be understood that this disclosure is provided for illustration purposes only. A person skilled in the relevant art will recognize that other components and configurations may be used without parting from the spirit and scope of this disclosure.

The invention provides a solution for the present need in the art for systems and methods for analyzing the grantability of legal filings. The invention solves the goldilocks principle of analyzing just the right amount of data points to identify how a judge will rule before a motion is submitted. Specifically, the data used in: (1) the type and size of each party, (2) the size of the law firms representing each party, (3) the nature of the suit as designated on the case docket, (4) a personal profile of the judge deciding the matter (i.e., the age, gender, political affiliation, years on the bench, and whether or not the American bar association recommended their seating), and (5) the decision history of the judge in prior litigation. In certain embodiments, the decision history of the judge may be restricted to the same types of motion filed in similar suits. In other embodiments, the decision history may be broader and cover the same types of motion filed regardless of whether the nature of the suit in which the prior filings were submitted were the same as the designation of the nature of the suit being analyzed.

In certain embodiments where the decision history of the judge may not have sufficient data to provide a meaningful analysis—such as when the judge is new to the bench or has not handled a statistically significant number of the relevant types of cases before the decision history of all the judges in the relevant district may be substituted. Again, the analysis may be restricted to decisions made in similarly designated suits or broadened to cover any type of suit.

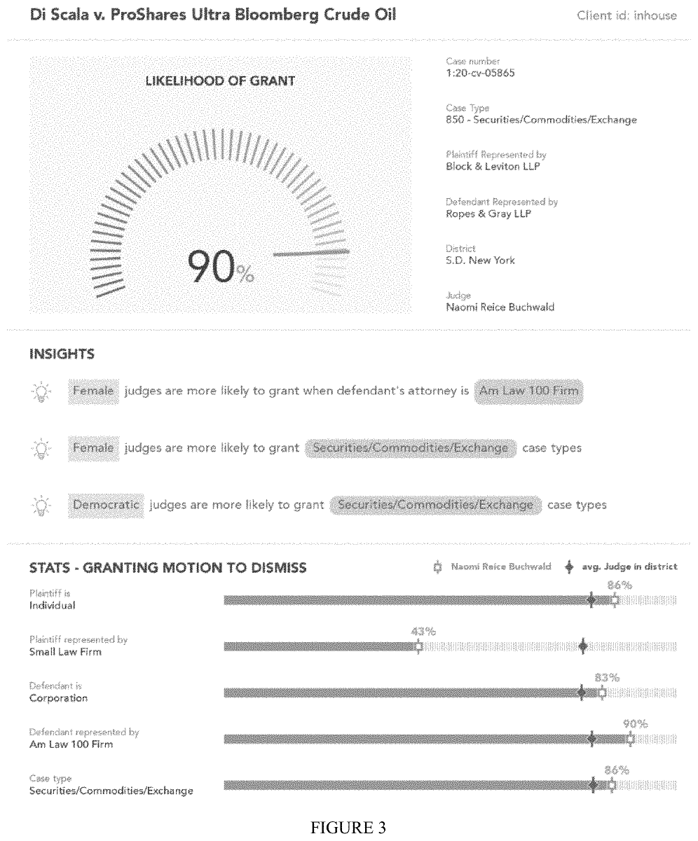

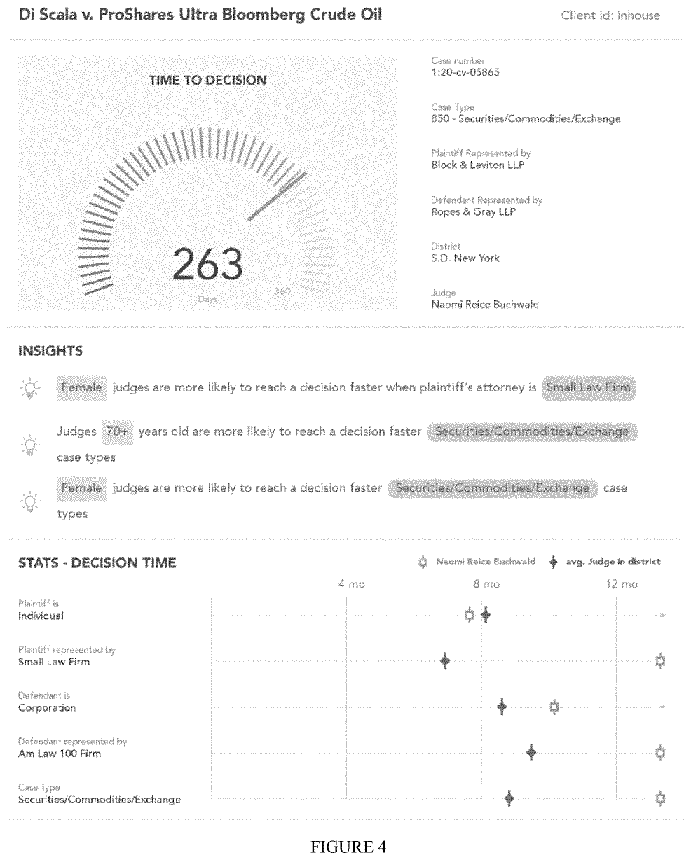

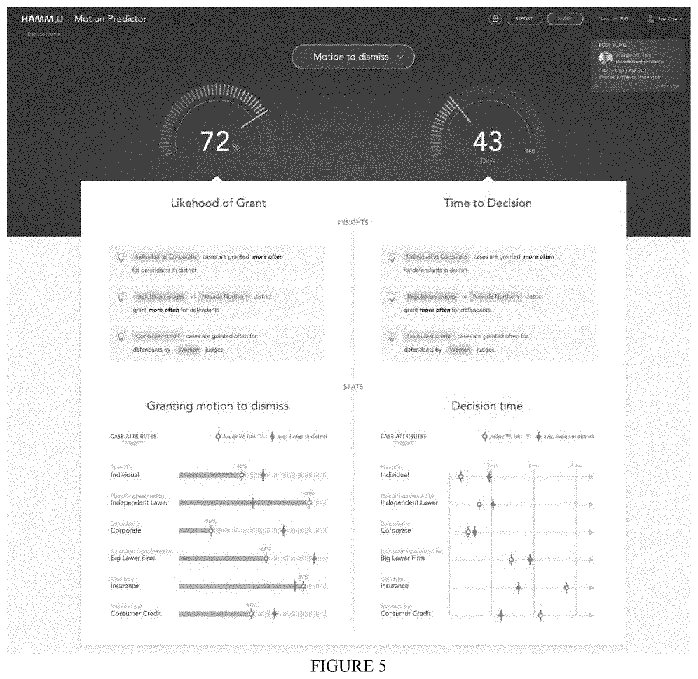

In other instances where the user wishes to compare the assigned judges to the entire bench, the results for the relevant judge may be overlaid over the results for the entire bench. Examples of such outputs from the software application are depicted in FIGS. 3-5.

A detailed discussion of the system and methods of the invention is provided below. First, a system overview is discussed. Second, the manner by which the system has been trained is discussed. Third, a gradient boosted platform, on which the present system and method are built is discussed. Fourth, the way a user may interact with the system is outlined. Fifth, the system components are identified. Sixth, a description of a cloud computing system, for the environment of this system, follows. Seventh, the collection and retention of relevant data is disclosed.

System Overview

The disclosed system and method centers around gradient boosted system and method for analyzing the grantability of a legal filing.

Data is input and conclusions are displayed via a software application operating on a user's computer or app located on the user's mobile computer device. In certain embodiments, the software application is served as a static JS content (Vue.JS-based) from Webserver, and HTML rendering of webapp takes place on client machine. The software application may communicate with the system via REST API endpoints exposed by Application server.

The software application includes custom code and may make use of various open source natural language processing (“NLP”) and machine learning libraries or packages. For example, Stanford CoreNLP and Spark MLlib, which provide implementations statistical analysis methods, techniques, and algorithms, may be used. The system runs on standard hardware disclosed in more detail below.

The system and method may be run on the cloud, such as Amazon Web Services located in the United States.

The primary storage for the system and method may consist of two or more database servers. For example, a first PostgreSQL database may be used to store PACER data in a relational database system, a second PostgreSQL database may then be used to store processed case records, metadata, and other application data.

Processed case records may be split into two categories, training and test data. The system and method use NLP on the training data to analyze docket sheets for state and federal courts (e.g., PACER) and complaints and identify key events described in the docket sheets, such as motions filed, orders that contain a decision on a filed motion, and the nature of the suit for each motion. NLP is also used to determine party type on the basis of party name alone in addition to analyzing and extracting relevant nature of suit information from complaints. ML, such as gradient boosting, is used to train prediction models from the training data.

The major technical challenges are in the training data collection phase, in which unstructured docket sheets are converted into structured motion data, as well as the “feature extraction” phase, in which raw case data is analyzed and features extracted into structured attributes.

Next, a Gradient Boosted Trees classifier algorithm is used to fit the case attribute data to the model, resulting in a prediction of expected outcome.

Motion outcome is predicted with classification predictive modeling, which approximates a mapping function from input variables to discrete output variables. Days to decision is predicted with regression predictive modeling.

The model has been tested on withheld training data (i.e., unseen by model), and accuracy is expressed as the percentage of correctly classified examples out of all predictions made was found to be greater than 84%.

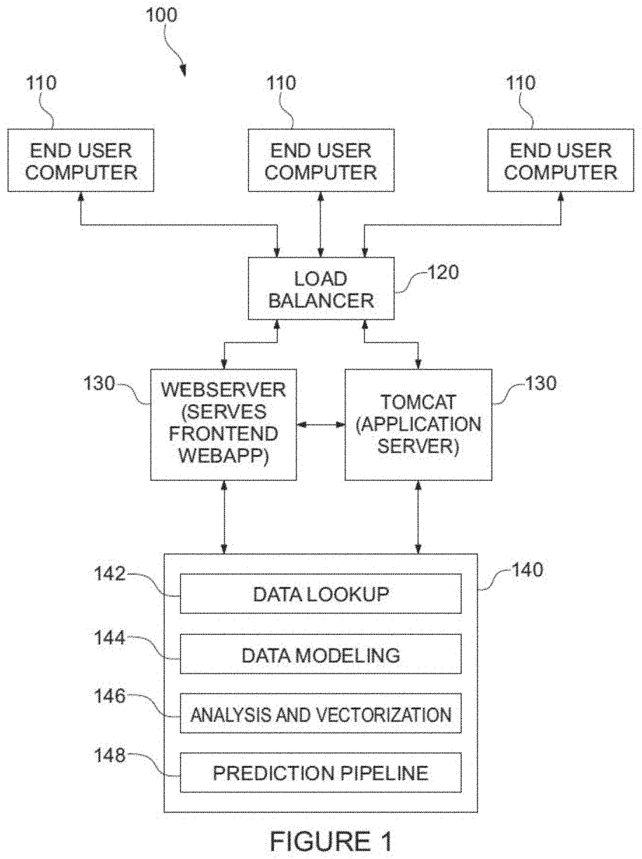

FIG. 1 depicts an embodiment of the system architecture. In the system 100, a user accesses the system via the user's computer device 110 and submits relevant case details (e.g., a docket number, law firm type, jurisdiction linked to a specific case, and an identification of the type of legal filing to be analyzed). A load balancer 120 distributes the incoming traffic across one or more servers 130 located at a site where the user is physically present or at a location remote from the site. In certain embodiments, the load balancer 120 distributes the incoming traffic between two servers 130. In such embodiments, a first server 130 may serve the frontend of the system (e.g., the graphical user interface) and a second server 130 may run the backend 140 of the system. The backend of the system 140 includes a data lookup module 142, a data modelling module 144, an analysis and vectorization module 146, and a predictive pipeline module 148. The data lookup module 142 is configured to recall from a database of the system, upon communication of the subject information to the server numeric values linked to the classification of: (a) party type, (b) corporation size, (c) law firm size, (d) nature of the suit, (e) type of filing, along with, prior numeric values linked to a prior decision history of the identified judge in relation to the legal filing being considered, wherein the numeric values linked to the classification and prior numeric values have been previously uploaded to the database by an administrator or programmer or an employee, contractor, or agent of the administrator or programmer. The data modelling module 144 is configured to use NLP to classify the information provided and assign numeric values to the information provided by the user to create a new entry. The analysis and vectorization module 146 creates a vector using the new entry and the prior numeric values. The predictive pipeline module 148 the solves the new vector using a gradient boosted trees classifier to determine the likelihood that the judge will grant the legal filing. Finally, the backend of the system 140 transmits the resulting solution to the software application for display to the user.

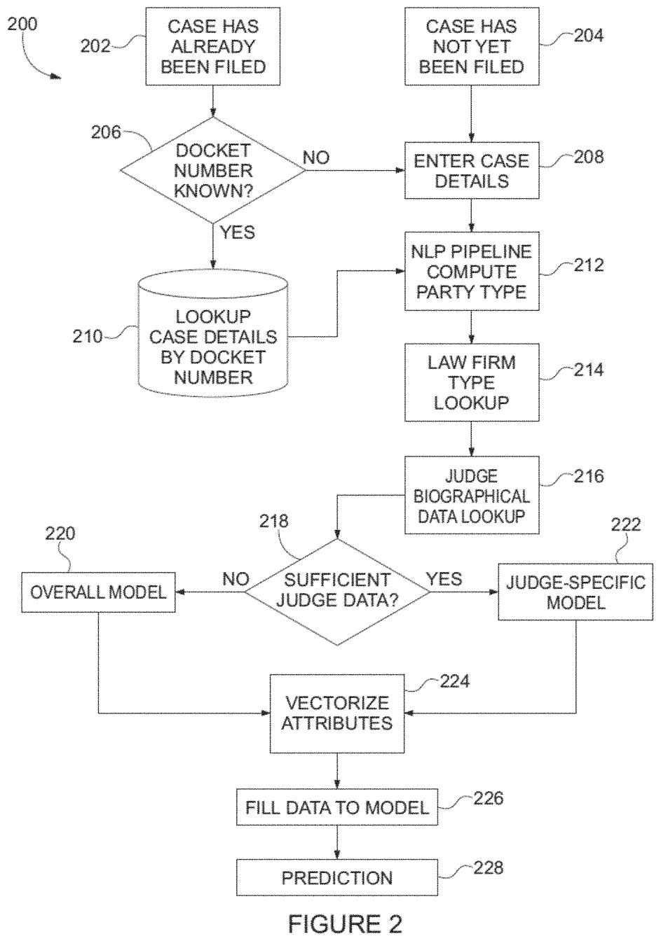

FIG. 2 depicts another embodiment of the system architecture. Specifically, how information flows. As depicted in FIG. 2, the user identifies if the case has been filed. If the case has been filed 202, the user provides the docket number 206. Upon receipt of the docket number, the system looks up case details 210 via electronically available docket systems (e.g., PACER). If the case has not been filed 204, the user manually submits case details to the system 208. Such a manual submission may occur via a graphical user interface. Upon receipt of the case details, whether automatically from an electronic docket or manually from the user, the system utilizes NLP to identify: (1) party types 212; (2) law firm types 214; and (3) the presiding judge 216. The system then determines if its database has sufficient prior data related to the decisions presiding judge 218. In the event the database lacks sufficient prior data related to the decisions of the presiding judge, the system calls up the prior data related to the decisions of similar filings for all judges within the relevant district for which it has sufficient prior date 220. Conversely, if the system has sufficient prior data related to the decisions of the presiding judge it calls up that data for use in modeling its predictive result 222. Regardless of whether the system has the necessary data or not, the system uses the identified data either data from all the judges in the district or the relevant judges to create a vector using the new entry and the prior numeric values 224. The system then fits the new vector 226 using a gradient boosted trees classifier to determine the likelihood that the judge will grant the legal filing. The system then displays the results 228.

System Training

The software application is capable of predicting real world outcomes with significant accuracy because as it has been previously trained. The training occurs via a serialized machine learning pipeline. The machine learning pipeline is the end-to-end construct that orchestrates the flow of data into, and output from, a machine learning model (or set of multiple models). It consists of six major phases: (1) business understanding; (2) data understanding; (3) data preparation; (4) modeling; (5) evaluation; and (6) deployment.

The first phase is business understanding. The key point in this phase is to understand the business problem to be solved. In this case, how to use a specific set of facts related to a legal case filed in a designated court in the United States to predict how likely the judge presiding over the case is to grant a specified motion. For example, a motion for judgment on the pleadings.

Once the business problem is understood, the next step is to identify where the data sources from which information will be collected. Examples and locations of the data sources are identified below. Preferably, this dataset is collected with labels from the source (e.g., name of plaintiff(s), defendant(s), or law firms identified on the public docket of the case) or labels are later manually assigned to the data collected (e.g., data related to the size of the law firm, or the type(s) of the plaintiff(s) or defendant(s)). With the labels assigned, the data is suitable for supervised machine learning.

Next, data preparation occurs. The main goal of data preparation is to clean and transform a collected raw dataset into appropriate format so that the transformed data can be effectively consumed by a target machine learning model. In the raw dataset, unique identifies (e.g., docket numbers) that do not have much prediction power are culled from the dataset. In addition, any inputs that lack any data are eliminated. Except for the date of any decision, all of the data in the dataset have categorical (i.e., textual) values. In order to use machine learning to solve the problem, those categorical values must be transformed into numeric values because a machine learning model can only consume numeric data. Furthermore, the date of prior decisions may be split into day, month, and year to increase prediction power since the information of individual day, month, and year may provide unknown correlations as compared with a string of date as a whole. For example, the Judge may be more inclined to issue decisions on a Friday. Examples of conversion of categorical data to numeric values is all governmental entities may be assigned a value of “1”, whereas corporate parties may be assigned a value of “2”. This conversion may be accomplished automatically, by a computer vision program using optical character recognition to review the categorical data and assign numerical data base don the results (e.g., party name that includes “State of” assigned a numeric value of “1” whereas a party name that includes “LLC” is assigned a numeric value of “2”), or individually by a system administrator or their employee, contractor, or agent.

Once the dataset has been prepared, the next step is modeling. The main goals of modeling include: (1) identify the machine learning model; (2) train the machine learning model; and (3) tune the hyper-parameters of the machine learning model. In certain embodiments of the system disclosed herein, the model is based on supervised machine learning and deep learning specifically, using a gradient boosted tree approach. With the identification of the model, there are multiple hyper-parameters to be tuned. A hyper-parameter is a parameter that needs to be set before a model training can begin and such hyper-parameter value does not change during model training. For example, the Gradient Boosted Tree approach has multiple hyper-parameters such as minimum number of decisions, maximum tree depth, etc.

Once a machine learning model has been trained with expected performance, the next step is to assess the prediction results of the model in a controlled close-to-real settings to gain confidence that the model is valid, reliable, and meets business requirements of deployment.

As an example, for the system disclosed herein, one possible method of evaluation is to use the system to evaluate the potential likelihood that a specific judge will grant a recently filed motion for judgment on the pleadings and the likely timeframe in which the judge will render their decision. These prediction results can then be used to generate a report (e.g., a table or csv file) for lawyers to review.

Once the model evaluation concludes that the model is ready for deployment, the final step is to deploy an evaluated model into a production system. In certain embodiments the system is deployed as a Web service on a server, which can be called by other components in a target production system to get prediction results for assisting lawyers in evaluating whether a specific judge will grant their motion for judgment on the pleadings. In some embodiments, the system will be reimplemented in a programming language that is different from the programming language used to train the system. For example, the system may be trained using Python but implemented in Java.

Gradient Boosted Platform

As outlined above, the system and method employ gradient boosted machines to assist in maximizing the likelihood that the system reliably predicts the grantability of a legal filing. Gradient boosting involves three elements: (1) a loss function to be optimized, (2) weak predictive model to make predictions; and (3) an additive model to add weak predictive models to minimize the loss function.

The loss function used depends on the type of problem being solved. It must be differentiable, but many standard loss functions are supported. For example, regression may use a squared error and classification may use logarithmic loss. In certain embodiments, squared error is used for regression, and logarithmic loss is used for classification. A benefit of the gradient boosting framework is that a new boosting algorithm does not have to be derived for each loss function that may want to be used, instead, it is a flexible enough framework that any differentiable loss function can be used.

In this case, decision trees are used as the weak predictive model. For example, regression trees may be used that output real values for splits and whose output can be added together, allowing subsequent models outputs to be added and “correct” the residuals in the predictions. Trees are constructed in a greedy manner, choosing the best split points based on purity scores or to minimize the loss. In certain cases, short decision trees may be used with only a single split, called a decision stump. Larger trees can, of course, be used generally with 4-to-8 levels.

In certain embodiments, the weak predictive models may be constrained in specific ways, such as a maximum number of layers, nodes, splits, or leaf nodes. This is to ensure that the learners remain weak but can still be constructed in a greedy manner.

Trees are added one at a time, and existing trees in the model are not changed. A gradient descent procedure is used to minimize the loss when adding trees. Traditionally, gradient descent is used to minimize a set of parameters, such as the coefficients in a regression equation or weights in a neural network. After calculating error or loss, the weights are updated to minimize that error. After calculating the loss to perform the gradient descent procedure, a tree is added to the model that reduces the loss (i.e. follows the gradient). Such a tree is selected by parameterizing the tree, then modifying the parameters of the tree and moving it in the right direction by reducing the residual loss. Generally, this approach is called functional gradient descent or gradient descent with functions.

The output for the new tree is then added to the output of the existing sequence of trees in an effort to correct or improve the final output of the model. A fixed number of trees are added or training stops once loss reaches an acceptable level or no longer improves on an external validation dataset.

As outlined above, gradient boosting is a greedy algorithm and can overfit a training dataset quickly. As a result, in certain embodiments, regularization methods that penalize various parts of the algorithm and generally improve the performance of the algorithm by reducing overfitting are employed. For example, tree constraints, shrinkage, random sampling, or penalized learning may be employed to mitigate overfitting. In certain embodiments, k-fold cross validation is used to optimize the number of iterations and other parameters.

Examples of the variable analyzed and boosted by the disclosed system and method are disclosed below. It will be appreciated that the below list is not meant to be exhaustive and other variable and data can be boosted and analyzed without departing from the true spirit and scope of the subject matter described herein. The data referenced below may be obtained, in whole or in part, from numerous sources, including: (1) PACER (https://www.pacer.gov/) for case information and machine learning or (2) Free Law Project (https://free.law) for additional case information and nature of suits.

Party Type

The system and method classify each party to a matter (i.e., the plaintiff(s) and defendant(s)) in the relevant cases in four ways. First, the parties are classified as either an individual, corporation, government, a union, or other. Second, if the party is designated a corporation, it is then classified by its size. For example, a corporation may be classified as a Fortune 100, Fortune 500, or Fortune 1000 company. Companies smaller than Fortune 1000 companies may be considered non-Fortune 1000 companies.

In other embodiments, a corporation may be classified by on various other industry-specific company lists previously uploaded to a system database by a programmer or an agent or employee of the programmer. For example, the company may be classified as an information technology, healthcare, financial, consumer discretionary, communication services, industrial, consumer staples, energy, utility, real estate, or materials company. Such designations may be based on sector breakdowns of major stock market indexes such as the S&P 500.

Law Firm Classification

The system and method classify each law firm assigned to each part of the relevant case according to size. Such classification may be by lawyer headcount or gross revenue. For example, a law firm with a single lawyer may be classified as a solo practitioner, a law firm with 2-50 lawyers may be classified as a small law firm, a law firm with 51-250 lawyers may be classified as a medium law firm, and a law firm with more than 251 lawyers may be classified as a big firm. In other embodiments, law firms listed on the Am 100 and Am 200 may be classified as such.

Such information can be obtained from any number of sources including Martindale (https://www.martindale.com/) and the American Lawyer.

In other embodiments, instead of inputting the firm name, the user may instead identify the firm type, either by size or revenue (am law) or leave the field as simply “unknown.”

Nature of the Suit

The system and method classify each action by the numeric nature of the suit identified on the docket sheet of the relevant action as assigned by the relevant court. In the event that the court uses alphabetic classification, the system may be adapted to convert such alphabetic classifications to the numeric classifications used by the federal courts.

In certain embodiments, the nature of the suit includes demand amounts, whether any jury demand(s) has been made, year filed, state filed in, and federal district filed in, if any.

Personal Profile of the Judge

The system and method will initially identify the name of the judge overseeing the relevant case. The system or method will then obtain from a database a judicial profile previously uploaded by a programmer or an agent or employee of the programmer or obtained from relevant databases identified below. The judicial profile will include the age, time on bench, gender, political affiliation, race, ABA rating, education, net worth, marital status, work history, clerkship, election contributions and voting records of the judge.

The system and method may supplement the personal profile of the judge with information from the following databases and data source: (1) proprietary judicial biographical information databases, such as FJC integrated databases (https://www.fjc.gov); (2) FEC databases to determine political contributions; (3) voter registration databases; (4) databases containing judicial financial information, including net worth from Senate Judiciary Committee questionnaires and financial disclosure forms, (5) the Almanac of the federal judiciary and (6) legislation confirmation reports (e.g., senate confirmation reports for federal judges).

Decision History of the Judge

The user will identify the type of filing being considered for submission. Based on this information and the name of the judge, the system or method will then obtain from a database a judicial decision profile previously uploaded by a programmer or an agent or employee of the programmer. In certain embodiments, the decision profile will identify how the judge has ruled on similar filings in similar cases. In other embodiments, the decision profile will identify how the judge has ruled on similar filings in all their cases.

In certain embodiments, the above data may initially be classified using letters, however, the system or method will convert the letter classification to a numeric classification to assist in creating the necessary vector to analyze the grantability of a proposed filing. In certain embodiments, the above data and databases are constantly monitored, and processed data is continuously updated. The predictive model is also occasionally rebuilt from the updated data and re-assessed through standard testing procedures.

A discussion of the systems and methods surrounding the invention of analyzing the grantability of legal filings below. First, an outline of the system and method is disclosed. Second, the components of the system are discussed. Third, a description of a cloud computing system, the preferred environment of the system, is then disclosed. Fourth, an exemplary embodiment of how the system would work is outlined.

Uses in Litigation Funding

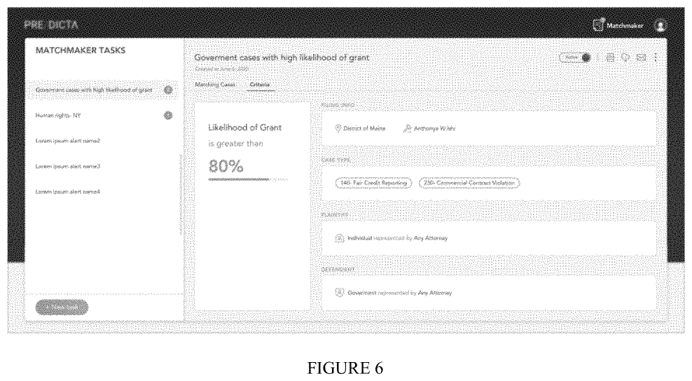

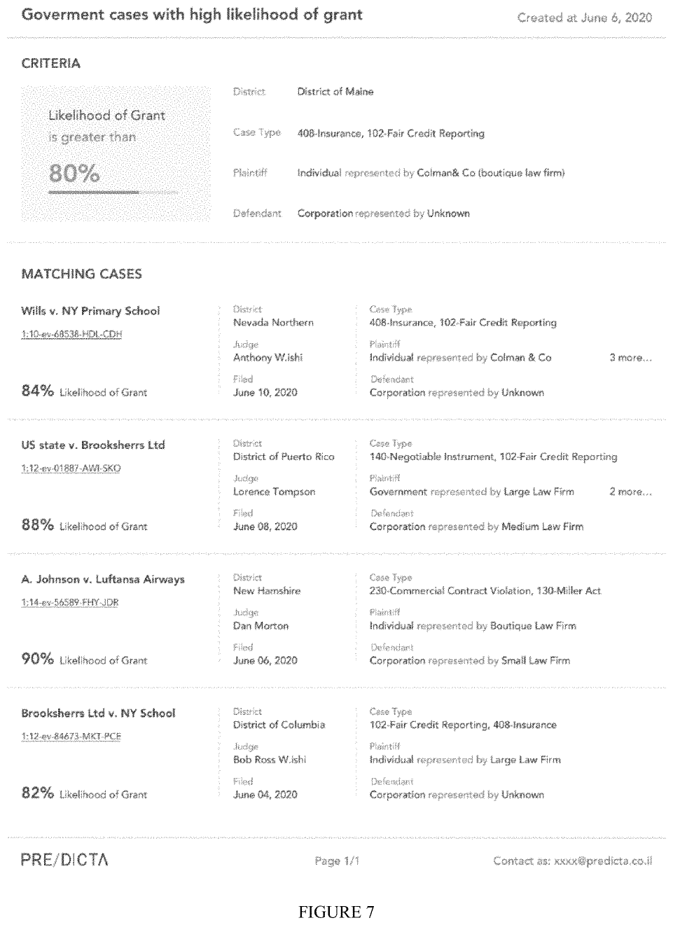

In certain embodiments, such as that depicted in FIGS. 6 and 7, a filtering function may be run on the results. The filter function may be set to run at designated times previously uploaded by the user, or an employee or agent of the user, such as once a day at 5:00 pm eastern, or it may be continuous. The function identifies all cases where a motion has a likelihood of being granted that is higher, or lower than a threshold value, previously uploaded by the user, or an employee or agent of the user. In such embodiments, the processor compares the determined likelihood of the motion to be granted to the threshold value and transmits the case identifiers that satisfy the threshold value to the software application for display. In other embodiments, additional filters can be applied to further restrict the cases identified and then displayed on the software application. Such additional filters, which are also previously uploaded to the database by the user, or an employee or agent of the user may be filters related to judicial district(s), specific judge(s), case type(s), party type(s), party name(s), law firm size, and specific law firm(s). Such continuous predictability may be employed by litigation funders to preemptively identify cases that may be economically viable for funding purposes.

In alternative embodiments, jurisdictions may be “sampled” for likely outcomes of a legal proceeding to identify the most favorable judge(s) for a litigant for a particular case. When no judge is assigned or designated and the judges are instead sampled, the system may analyze every judge within a single or multiple districts designated by the user. In such embodiments, the user must identify the nature of suit and the jurisdiction or jurisdictions that they are contemplating filing. In such embodiments, the user is not required to identify the specific parties or attorneys. Instead, the user has the option of merely identifying the party type, corporation, union, government, individual, or other. The system or method will then obtain from a database a judicial profile of all judges in the selected districts which have been previously uploaded by a programmer or an agent or employee of the programmer or obtained from relevant databases identified above. The judicial profile will include the age, time on bench, gender, political affiliation, race, ABA rating, education, net worth, marital status, work history, clerkship, election contributions and voting records of each judge.

System Components

The system includes a general-purpose computing device, including a processing unit (CPU or processor), and a system bus that couples various system components including the system memory such as read only memory (ROM) and random-access memory (RAM) to the processor. The system can include a storage device connected to the processor by the system bus. The system can include interfaces connected to the processor by the system bus. The system can include a cache of high speed memory connected directly with, in close proximity to, or integrated as pmi of the processor. The system can copy data from the memory and/or a storage device to the cache for quick access by the processor. In this way, the cache provides a performance boost that avoids processor delays while waiting for data. These and other modules stored in the memory, storage device or cache can control or be configured to control the processor to perform various actions. Other system memory may be available for use as well. The memory can include multiple different types of memory with different performance characteristics.

Computer Processor

It can be appreciated that the invention may operate on a computing device with more than one processor or on a group or cluster of computing devices networked together to provide greater processing capability. The processor can include any general-purpose processor and a hardware module or software module, stored in an external or internal storage device, configured to control the processor as well as a special-purpose processor where software instructions are incorporated into the actual processor design. The processor may essentially be a completely self-contained computing system, containing multiple cores or processors, a bus, memory controller, cache, etc. A multi-core processor may be symmetric or asymmetric.

For clarity of explanation, an illustrative system embodiment may be presented as including individual functional blocks including functional blocks labeled as a “processor”. The functions such blocks represent may be provided through the use of either shared or dedicated hardware, including, but not limited to, hardware capable of executing software and hardware, such as a processor, that is purpose-built to operate as an equivalent to software executing on a general-purpose processor. For example, the functions of one or more processors may be provided by a single shared processor or multiple processors and use of the term “processor” should not be construed to refer exclusively to hardware capable of executing software. Illustrative embodiments may include microprocessor and/or digital signal processor (DSP) hardware, read-only memory (ROM) for storing software performing the operations discussed below, and random-access memory (RAM) for storing results. Very large-scale integration (VLSI) hardware embodiments, as well as custom VLSI circuitry in combination with a general-purpose DSP circuit, may also be provided.

System Bus

The system bus may be any of several types of bus structures including a memory bus or memory controller, a peripheral bus, and a local bus using any of a variety of bus architectures. A basic input/output (BIOS) stored in ROM or the like, may provide the basic routine that helps to transfer information between elements within the computing device, such as during start-up.

Storage Device

The computing device can further include a storage device such as a hard disk drive, a magnetic disk drive, an optical disk drive, a solid-state drive, a tape drive, or the like. Similar to the system memory, a storage device may be used to store data files, such as location information, menus, software, wired and wireless connection information (e.g., information that may enable the mobile device to establish a wired or wireless connection, such as a USB, Bluetooth or wireless network connection), and any other suitable data. Specifically, the storage device and/or the system memory may store code and/or data for carrying out the disclosed techniques among other data.

In one aspect, a hardware module that performs a particular function includes the software component stored in a non-transitory computer-readable medium in connection with the necessary hardware components, such as the processor, bus, display, and so forth, to carry out the function. The basic components are known to those of skill in the art and appropriate variations are contemplated depending on the type of device, such as whether the device is a small, handheld computing device, a desktop computer, or a computer server.

Although the preferred embodiment described herein employs cloud computing and cloud storage, it should be appreciated by those skilled in the art that other types of computer readable media which can store data that are accessible by a computer, such as magnetic cassettes, flash memory cards, digital versatile disks, cartridges, random access memories (RAMS), read only memory (ROM), a cable or wireless signal containing a bit stream and the like, may also be used in the operating environment. Furthermore, non-transitory computer-readable storage media as used herein include all computer-readable media, with the sole exception being a transitory propagating signal per se.

Interface

To enable user interaction with the computing device, an input device represents any number of input mechanisms, such as a microphone for speech, a touch-sensitive screen for gesture or graphical input, keyboard, mouse, motion input, speech and so forth. An output device can also be one or more of a number of output mechanisms known to those of skill in the art such as a display screen, speaker, alarm, and so forth. In some instances, multimodal systems enable a user to provide multiple types of input to communicate with the computing device. The communications interface generally governs and manages the user input and system output. Furthermore, one interface, such as a touch screen, may act as an input, output, and/or communication interface.

There is no restriction on operating on any particular hardware arrangement and therefore the basic features here may easily be substituted for improved hardware or firmware arrangements as they are developed.

Software Operations

The logical operations of the various embodiments disclosed are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system can practice all or part of the recited methods, can be a part of the recited systems, and/or can operate according to instructions in the recited non-transitory computer-readable storage media. Such logical operations can be implemented as modules configured to control the processor to perform particular functions according to the programming of the module. For example, if a storage device contains modules configured to control the processor. These modules may be loaded into RAM or memory at runtime or may be stored as would be known in the art in other computer-readable memory locations. Having disclosed some components of a computing system, the disclosure now turns to a description of cloud computing, which is the preferred environment of the invention.

Cloud System

Cloud computing is a type of Internet-based computing in which a variety of resources are hosted and/or controlled by an entity and made available by the entity to authorized users via the Internet. A cloud computing system can be configured, wherein a variety of electronic devices can communicate via a network for purposes of exchanging content and other data. The system can be configured for use on a wide variety of network configurations that facilitate the intercommunication of electronic devices. For example, each of the components of a cloud computing system can be implemented in a localized or distributed fashion in a network.

Cloud Resources

The cloud computing system can be configured to include cloud computing resources (i.e., “the cloud”). The cloud resources can include a variety of hardware and/or software resources, such as cloud servers, cloud databases, cloud storage, cloud networks, cloud applications, cloud platforms, and/or any other cloud-based resources. In some cases, the cloud resources are distributed. For example, cloud storage can include multiple storage devices. In some cases, cloud resources can be distributed across multiple cloud computing systems and/or individual network enabled computing devices. For example, cloud computing resources can communicate with a server, a database, and/or any other network enabled computing device to provide the cloud resources.

In some cases, the cloud resources can be redundant. For example, if cloud computing resources are configured to provide data backup services, multiple copies of the data can be stored such that the data is still available to the user even if a storage resource is offline, busy, or otherwise unavailable to process a request. In another example, if a cloud computing resource is configured to provide software, the software can be available from different cloud servers so that the software can be served from any of the different cloud servers. Algorithms can be applied such that the closest server or the server with the lowest current load is selected to process a given request.

User Terminals

A user interacts with cloud computing resources through user terminals connected to a network by direct and/or indirect communication. Cloud computing resources can support connections from a variety of different electronic devices, such as servers; desktop computers; mobile computers; handheld communications devices (e.g., mobile phones, smart phones, tablets); set top boxes; network-enabled hard drives; and/or any other network-enabled computing devices. Furthermore, cloud computing resources can concurrently accept connections from and interact with multiple electronic devices. Interaction with the multiple electronic devices can be prioritized or occur simultaneously.

Cloud computing resources can provide cloud resources through a variety of deployment models, such as public, private, community, hybrid, and/or any other cloud deployment model. In some cases, cloud computing resources can support multiple deployment models. For example, cloud computing resources can provide one set of resources through a public deployment model and another set of resources through a private deployment model.

In some configurations, a user terminal can access cloud computing resources from any location where an Internet connection is available. However, in other cases, cloud computing resources can be configured to restrict access to certain resources such that a resource can only be accessed from certain locations. For example, if a cloud computing resource is configured to provide a resource using a private deployment model, then a cloud computing resource can restrict access to the resource, such as by requiring that a user terminal access the resource from behind a firewall.

Service Models

Cloud computing resources can provide cloud resources to user terminals through a variety of service models, such as Software as a Service (SaaS), Platforms as a service (PaaS), Infrastructure as a Service (IaaS), and/or any other cloud service models. In some cases, cloud computing resources can provide multiple service models to a user terminal. For example, cloud computing resources can provide both SaaS and IaaS to a user terminal. In some cases, cloud computing resources can provide different service models to different user terminals. For example, cloud computing resources can provide SaaS to one user terminal and PaaS to another user terminal.

User Interaction

In some cases, cloud computing resources can maintain an account database. The account database can store profile information for registered users. The profile information can include resource access rights, such as software the user is permitted to use, maximum storage space, etc. The profile information can also include usage information, such as computing resources consumed, data storage location, security settings, personal configuration settings, etc. In some cases, the account database can reside on a database or server remote to cloud computing resources such as servers or database.

Cloud computing resources can provide a variety of functionality that requires user interaction. Accordingly, a user interface (UI) can be provided for communicating with cloud computing resources and/or performing tasks associated with the cloud resources. The UI can be accessed via an end user terminal in communication with cloud computing resources. The UI can be configured to operate in a variety of client modes, including a fat client mode, a thin client mode, or a hybrid client mode, depending on the storage and processing capabilities of cloud computing resources and/or the user terminal. Therefore, a UI can be implemented as a standalone application operating at the user terminal in some embodiments. In other embodiments, a web browser-based portal can be used to provide the UI. Any other configuration to access cloud computing resources can also be used in the various embodiments.

### EXAMPLES

The following example is included to more clearly demonstrate the overall nature of the invention. The example illustrates the manner by which the system and method address the goldilocks principle identified above by using just the right amount and mix of data in the gradient boosting approach so that the result is accurate, but not overfitted. This example is exemplary, not restrictive, of the invention.

The user inputs case identifier or docket number. The case details are retrieved from case database (e.g., PACER) and displayed to the user. The user may optionally add missing details or additional data, such as additional nature of suit information or party/attorney information. The completed case details are input to the system. Relevant attributes are computed from complete case details. For example, party names are analyzed with at least one NLP pipeline to determine party types, law firm sizes are obtained from databases and assigned to the relevant firms, and the assigned judge's biographical attributes are obtained from a judicial biography database. Next, a machine learning pipeline is chosen. The pipeline may be either a judge specific model for judges with sufficient data, or an overall model for all others. Case attributes are input into the chosen machine learning pipeline, which translates attributes into a numeric vector. The machine learning pipeline fits the data using at least one gradient boosted trees classifier, resulting in a predicted label or outcome. The predicted label or outcome is then displayed to the user.

In certain embodiments, the case details may be input directly by the user.

In addition, this is not a one-shot system. The system is capable of handling multiple options input by user with the ability to multiselect parameters for comparison purposes. Results of each unique option are output to user, and the “best” choice for each dimension (outcome and days to decision) may be flagged.

While this subject matter has been disclosed with reference to specific embodiments, it is apparent that other embodiments and variations can be devised by others skilled in the art without departing from the true spirit and scope of the subject matter described herein.

What is claimed is:

1. A system for indirectly analyzing and providing a likelihood that a legal filing being considered will be granted, the system comprising:
a software application, the application operating on a mobile computer device or on a computer device, which is in communication with a user, the application is configured to receive the following subject information from the user: a docket number and jurisdiction linked to a specific case, and an identification of the legal filing, wherein, the software application is further configured to communicate the subject information through a wired and/or wireless communication network to a server located at a site where the user is physically present or at a location remote from the site; and
a processor that is in communication through the wired and/or wireless communication network with the software application, as well as the server, the processer is configured to:
request and receives from either an electronic public access service of United States that provides federal court documents, the user, or an employee or agent of the user: (1) names of parties to the case; (2) names of law firms linked to each party; (3) name of judge assigned to the case; and (4) nature of the suit,
classify, using natural processing language as applied to the names: (1) each party type and (2) each law firm by size, and
recall from a database of the system, upon communication of the subject information to the server numeric values linked to the classification of: (a) party type, (b) corporation size, (c) law firm size, (d) nature of the suit, (e) type of filing, along with, prior numeric values linked to a prior decision history of the judge in relation to the legal filing being considered, wherein the numeric values linked to the classification and prior numeric values have been previously uploaded to the database by a programmer or an employee, contractor, or agent of the programmer;
whereby the processor converts each classification to the relevant numeric value linked to the classification to create a new entry and creates a vector using the new entry and the prior numeric values;
whereby the processor solves the new vector using a gradient boosted trees classifier to determine the likelihood that the judge will grant the legal filing; and
transmits the resulting solution to the software application for display to the user.

2. The system of claim 1 wherein the prior decision history further contains the length of time the judge took to issue prior decisions and the processor transmits the length of time to the software application for display to the user.

3. The system of claim 1 wherein the party type is selected from a group consisting of individual, corporation, government, a union, and other.

4. The system of claim 3 where a corporation size is further selected from a group consisting of a Fortune 100 company, Fortune 500 company, Fortune 1000 company, and a non-Fortune 1000 company.

5. The system of claim 1 wherein the law firm size is selected from a group consisting of a solo practitioner, a small law firm, a medium law firm, a big firm, wherein a big firm is further selected from a group consisting of an Am 100 firm and an Am 200 firm.

6. The system of claim 1 wherein the nature of suit is selected from a group consisting of an alphabetic classifications used by United States federal courts.

7. The system of claim 1 wherein the type of filing is selected from a group consisting of motions for judgment on the pleadings and filings invoking Federal Rule of Civil Procedure 12(b)(6).

8. A system for indirectly analyzing and providing a likelihood that a legal filing being considered will be granted, the system comprising:
a software application, the application operating on a website accessible through a wired or wireless communications network by a unique mobile computer device, which is in communication with a user, the application is configured to receive the following subject information from the user: a docket number and jurisdiction linked to a specific case, and an identification of the legal filing, wherein, the software application is further configured to communicate the subject information through a wired and/or wireless communication network to a server located at a site where the user is physically present or at a location remote from the site; and
a processor that is in communication through the wired and/or wireless communication network with the unique mobile computer device and/or computer device, as well as the server, the processer is configured to:
request and receives from either an electronic public access service of United States that provides federal court documents, the user, or an employee or agent of the user: (1) names of parties to the case; (2) names of law firms linked to each party; (3) name of judge assigned to the case; and (4) nature of the suit,
classify, using natural processing language as applied to the names: (1) each party type and (2) each law firm by size, and
recall from a database of the system, upon communication of the subject information to the server numeric values linked to the classification of: (a) party type, (b) corporation size, (c) law firm size, (d) nature of the suit, (e) type of filing, along with, prior numeric values linked to a prior decision history of the judge in relation to the legal filing being considered, wherein the numeric values linked to the classification and prior numeric values have been previously uploaded to the database by a programmer or an employee, contractor, or agent of the programmer;
whereby the processor converts each classification to the relevant numeric value linked to the classification to create a new entry and creates a vector using the new entry and the prior numeric values;
whereby the processor solves the new vector using a gradient boosted trees classifier to determine the likelihood that the judge will grant the legal filing; and
transmits the resulting solution to the software application for display to the user.

9. The system of claim 8 wherein the prior decision history further contains the length of time the judge took to issue prior decisions and the processor transmits the length of time to the software application for display to the user.

10. The system of claim 8 wherein the party type is selected from a group consisting of individual, corporation, government, a union and other.

11. The system of claim 10 where a corporation size is further selected from a group consisting of a Fortune 100 company, Fortune 500 company, Fortune 1000 company, and a non-Fortune 1000 company.

12. The system of claim 8 wherein the law firm size is selected from a group consisting of a solo practitioner, a small law firm, a medium law firm, a big firm, wherein a big firm is further selected from a group consisting of an Am 100 firm and an Am 200 firm.

13. The system of claim 8 wherein the nature of suit is selected from a group consisting of an alphabetic classifications used by United States federal courts.

14. The system of claim 8 wherein the type of filing is selected from a group consisting of motions for judgment on the pleadings and filings invoking Federal Rule of Civil Procedure 12(b)(6).

15. A method for indirectly analyzing and providing a likelihood that a legal filing being considered will be granted, the method comprising:
receiving the following initial information that has been provided by a user using a software application operating on a mobile computer device or a computer device that is synchronized with the mobile computer device: a docket number and jurisdiction linked to a specific case, and an identification of the legal filing;
receiving the following additional information from either an electronic public access service of United States that provides federal court documents, the user, or an employee or agent of the user: (1) names of parties to the case; (2) names of law firms linked to each party; (3) name of judge assigned to the case; and (4) nature of the suit;
upon receiving the additional information, classifying, using natural processing language as applied to the names: (1) each party as a corporation, individual, union, government, or other, wherein the corporations are further classified by size and (2) each law firm is a solo, small firm, medium firm, large firm, or Am 100 firm,
upon receiving the additional information calling up: numeric values linked to the classification of (a) party type, (b) corporation size, (c) law firm size, (d) nature of the suit, (e) type of filing, along with, prior numeric values linked to a prior decision history of the judge in relation to the legal filing being considered, wherein the numeric values linked to the classification and prior numeric values have been previously uploaded to the database by a programmer or an employee, contractor, or agent of the programmer;
converting each classification to the relevant numeric value linked to the classification to create a new entry;
creating a vector using the new entry and the prior numeric values;
solving the new vector using a Gradient Boosted Trees classifier to determine the likelihood that the judge will grant the legal filing; and
displaying the resulting likelihood that the judge will grant the legal filing to the user.

16. The method of claim 15 wherein the prior decision history further contains the length of time the judge took to issue prior decisions and the method further comprises determining the average time that the judge takes to issue prior decisions on related filings.

17. The method of claim 15 wherein the party type is selected from a group consisting of individual, corporation, government, a union and other and the party type is further selected from a group consisting of a Fortune 100 company, Fortune 500 company, Fortune 1000 company, and a non-Fortune 1000 company.

18. The method of claim 15 wherein the law firm size is selected from a group consisting of a solo practitioner, a small law firm, a medium law firm, a big firm, wherein a big firm is further selected from a group consisting of an Am 100 firm and an Am 200 firm.

19. The method of claim 15 wherein the nature of suit is selected from a group consisting of an alphabetic classifications used by United States federal courts.

20. The method of claim 15 wherein the type of filing is selected from a group consisting of motions for judgment on the pleadings and filings invoking Federal Rule of Civil Procedure 12(b)(6).
